(19) United States
(12) Patent Application Publication
(10) Pub. No.: US 2010/0092790 A1
(43) Pub. Date: Apr. 15, 2010

(54) MOLDED OR EXTRUDED COMBINATIONS OF LIGHT METAL ALLOYS AND HIGH-TEMPERATURE POLYMERS

(75) Inventors: Aihua A. Luo, Troy, MI (US); William R. Rodgers, Bloomfield Township, MI (US); Charles K. Buehler, Warren, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/250,711

(22) Filed: Oct. 14, 2008

(51) Int. Cl. B32B 15/08; B29C 47/00

(52) U.S. Cl. 428/457; 264/241

(57) ABSTRACT

Hybrid articles comprising a molded mixture of a light metal alloy and a polymer are formed by processing (including co-molding and co-extruding) the metal in a semi-solid state at a high shear rate and the polymer in a melt processable state. For example, magnesium alloy particles in a thixotropic condition are mixed with particles or globules of the polymer and molded into a hybrid metal-containing and polymer-containing body. The proportions of magnesium and polymer may be varied substantially depending on the desired properties of the hybrid article. In another embodiment the light metal and polymer may be co-extruded as two or more distinct layers into a solid or hollow hybrid body.

### TECHNICAL FIELD

This invention pertains to molded or extruded combinations of aluminum or magnesium alloys and a high temperature polymer such as a liquid crystal polymer. More specifically this invention pertains both to co-molded mixtures comprising mixed light metal and polymer phases, and it pertains to co-extruded articles comprising distinct layers of light metal and polymer.

### BACKGROUND OF THE INVENTION

There are many part applications in automotive vehicles that could utilize a combination of a polymeric layer or phase with a light metal layer or phase, particularly where such hybrid parts are light weight and display material stability and dimensional stability at temperatures experienced in vehicle engine compartments and close to exhaust systems. Examples of candidate parts include intake manifolds, exhaust manifold parts, valve covers, fuel injection components, supercharger components, grille opening retainers, spoilers, and roof rails. Such hybrid material combinations may include materials with a predominant phase or matrix phase of polymer with a dispersed metal phase, or vice versa. There are also vehicle parts that may be formed of co-extruded bars or tubes comprising distinct but overlying and contacting layers of polymer and metal alloy.

Thus, there is a need for such light weight hybrid parts where a combination of polymer and metal materials can be identified and processed into hybrid parts by efficient manufacturing processes that can provide suitable mixtures of phases of the polymer and metal constituents or co-extruded layers of them.

### SUMMARY OF THE INVENTION

This invention comprises forming material combinations of a light metal alloy and a high temperature polymer. The proportions and structural arrangement of the metal constituent and polymer constituent are predetermined for the physical and chemical requirements of the article to be formed of them.

The metal alloy may be an aluminum alloy or a magnesium alloy. The very light weight magnesium alloys are preferred for vehicle applications, particularly in weight saving applications. Magnesium alloy AZ91, an aluminum and zinc-containing, magnesium-based alloy is an example of a suitable alloy for high-strength applications. Other magnesium alloys, AM50 and AM60, aluminum and manganese-containing, magnesium-based alloys are examples of suitable alloys for high ductility applications. The polymeric constituent of the material combination is preferably a high temperature resistant polymer such as certain melt processable liquid crystal polymers and certain melt processable polyimides, polyether imides, or polysulfones.

In one embodiment of the invention the material combination comprises a molded mixture of particles of the metal and the polymer. In this embodiment particles of a suitable magnesium alloy and particles of a polymer composition are suitably subjected to a thixotropic injection molding process. The temperatures and shear rates of the respective materials in the molding operation are in a range in which the metal particles are in a semi-molten state and the polymer particles are suitably melt processable to mix with each other and to be forced under pressure into a mold. The mold cavity may be shaped to define a desired finish shape of a hybrid metal/polymer article or a precursor shape of the mixed metal/polymeric material for further processing or shaping.

The proportions of the magnesium alloy (or other light metal alloy) and liquid crystal polymer (or other high temperature polymer) may be varied from a large preponderance of metal to a large preponderance of polymer. Depending on the volume percentage of each constituent, different hybrid product morphologies could be prepared which would have properties based on the microstructure. A hybrid material may, for example, have a magnesium alloy as the continuous phase(s) with discreet liquid crystal polymer phases, or various types of co-continuous phases, or discreet magnesium alloy phases in a liquid crystal polymer matrix. Variations in proportions of magnesium alloy and high temperature polymer will yield hybrid composition microstructures that provide various reinforcement levels, dimensional stabilities, oxidative stability, and mechanical properties.

In another embodiment of the invention, multilayer co-extrusions are formed where the magnesium and polymer are in alternating layers. A high temperature polymer is selected for co-extrusion with a magnesium or aluminum alloy at suitable extrusion temperatures. Various arrangements of the metal and polymer layers may be formed in light weight hollow and solid sections. For example, a suitably stiff or strong metal inner layer may be formed with an outer corrosion-resistant polymer layer. A polymer inner layer and metal outer layer may be devised for desirable acoustic properties. And multilayer metal and polymer extrusions may be designed with arrangements of metal and polymer layers of different properties. This co-extrusion embodiment of the invention provides hybrid articles with tailored layered properties for many applications.

In practices of this invention, high temperature polymers with melt processable temperatures of the order of about 350° C. are molded or co-extruded with light weight aluminum or magnesium alloys which may be extruded or molded by thixotropic processes at temperatures (often in the range of about 320° C. to about 400° C.) overlapping the molding temperature of the selected polymer.

Other objects and advantages of the invention will be apparent from a further description of illustrative embodiments which follows in this specification.

### BRIEF DESCRIPTION OF THE DRAWINGS

FIG. 1 is a schematic elevation view, partly in cross-section, of an injection molding machine and mold for co-molding particles of a light metal alloy and polymer pellets into a hybrid molded body. The drawing illustrates a first feeder for a metal/polymer mixture and an optional second feeder when it is preferred to add the polymer downstream of the metal.

FIG. 2 is a schematic elevation view, in cross-section, of an extrusion machine for co-extruding three distinct layers of polymer and metal in the shape of a hollow tube. In this illustration a polymer layer may be sandwiched between inner and outer metal layers, or vice versa.

### DESCRIPTION OF PREFERRED EMBODIMENTS

This invention utilizes a light metal alloy(s) material and a high temperature polymer(s) material that may be combined into a hybrid article by an injection molding type process or an extrusion type process.

In a typical molding process, a material is heated and maintained at a temperature in which it will flow under a molding pressure. The fluid material is often moved with one or more screws through a tube and forced under pressure (injected) into a desired mold cavity. The mold cavity is vented and the hot material is injected under such pressure that a substantially non-porous body is formed that conforms to the shape of the cavity surfaces. The molding process may be a thixotropic process in which the temperature of the metal and polymer constituents are heated to temperatures at which the metal is a fluid semi-solid and the polymer will also flow under pressure. In this state, the metal and polymer are intimately mixed and molded.

In other embodiments, the extrusion process may be a co-extrusion process in which predetermined proportions of metal and polymer are fed along the same path in layers of suitable thickness through an orifice that joins them in two or more layers. A long solid or a long hollow article is formed with a layered cross-section of a desired arrangement of metal and polymer layers.

Light metal alloys of aluminum or magnesium are used in the practice of the invention. Examples of suitable aluminum alloys include A380 (Al-8% Si-3% Cu), A356 (Al-7% Si-0.4% Mg), and A514 (Al-4% Mg). Examples of magnesium-based alloys and a nominal composition include AZ91D (Mg-9% Al-0.8% Zn), AM60B (Mg-6% Al-0.3% Mn), and AM50 (Mg-5% Al-0.3% Mn). In many embodiments it is preferred to use a magnesium alloy because they are lighter (volume for volume) than aluminum and lend themselves particularly well to thixotropic and other molding processes at temperatures compatible with molding of high temperature polymers without significant thermal degradation of the polymer.

As stated, polymers are used in the practice of the invention that are melt processable and capable of being molded or co-extruded with a light metal alloy. Some liquid crystal polymers and some other high temperature polymers are sufficiently stable at molding temperatures required for magnesium and aluminum alloys. For example, some aromatic polyesters based on p-hydroxybenzoic acid (HBA), bisphenol, and phthalic acid and related monomers are capable of forming regions of highly ordered structure in the liquid phase. Other, similar polyesters are copolymers of HBA and 6-hydroxy-2-naphthoic acid or copolymers of HBA, 4,4′-bisphenol and terephthalic acid. This class of liquid crystal polymers has high temperature stability and good strength. They can be molded at temperatures of the order of about 320° C. or higher and, thus, can be combined with magnesium alloys or aluminum alloys in a thixotropic molding process or co-extrusion process to make hybrid articles as contemplated in this invention. Polysulfones, polyimides, and polyether imides are other groups of high temperature stable, melt-processable polymers that may be likewise molded into hybrid articles by practices of this invention.

A hybrid mixture of metal and polymer phases may be prepared by a molding process in which the metal constituent is heated to a semi-solid state and moved toward a mold using high shear rate mixing. The metal (for example, magnesium AZ91 alloy) then comprises a liquid phase with higher melting solid globules. A quantity of the polymer may be introduced into the semi-solid metal material. The polymer may have been preheated before it contacts the semi-solid metal or it may be heated by the moving metal. The polymer is converted to a melt which is mixed with the semi-solid metal. High shear rate mixing of the complex mixture is continued until the mixture is injected under high pressure into a mold cavity. The injection is such that the mixture takes the shape of the mold surfaces with little entrained porosity. The molded hybrid mixture may then have a precursor shape for further processing or it may have a desired final molded shape. The microstructure of the hybrid mixture depends upon the respective compositions of the metal alloy and the polymer and the proportions of each in the mixture. Where a suitable abundance of the metal is present, the molded body may have a continuous metal phase with an entrained small-particle polymer phase. In this case the polymer modifies the properties of a magnesium alloy or aluminum alloy article. Where a suitable abundance of the polymer is present, a hybrid article in the nature of a metal-particle-filled polymer may be formed. Obviously, other article characteristics may be obtained by selecting relative compositions and proportions of metal alloy and polymer.

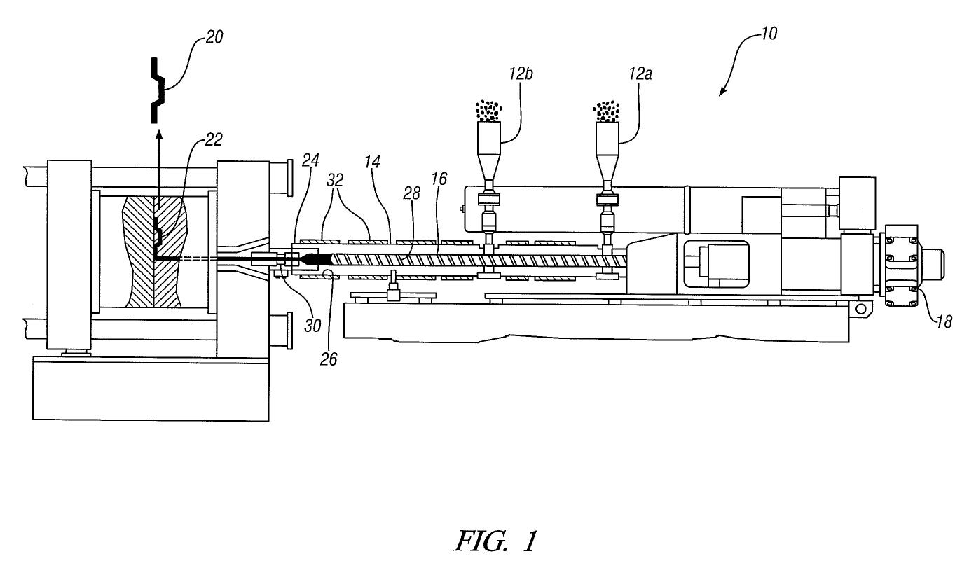

FIG. 1 is a schematic illustration of an injection molding machine 10 for high shear mixing and temperature control of forming a mixture of a thixotropic mass of metal and particles or globules of a polymer. The molding machine 10 is capable of forming a net shape or near-net shape hybrid article 20 that comprises a light metal/polymer hybrid combination material. The injection molding machine 10 shown is constructed to inject a shot of hybrid mixture material into a mold cavity 22 and generally includes at least one hopper or feeder 12a, 12b, a barrel 14, a screw 16, and a drive mechanism 18. The machine 10 operates generally to form the hybrid article 20 by first receiving a predetermined amount of metal and polymer feedstock into the barrel 14—which may be externally heated—through the one or more feeders 12a, 12b. The screw 16 then rotates and simultaneously mixes the feedstock materials at high shear rates and translates the mixed material axially towards the injection end 24 of the barrel 14. An appropriate shot of hybrid combination material is ultimately forced from the barrel 14 and into the mold cavity 22 which is oftentimes defined by a pair of complimentary die halves (illustrated in a mold closed position). The hybrid material supplied to the mold cavity 22, as described earlier, may vary in concentration from substantially metallic-based to substantially polymer-based as well as any intermittent concentration therebetween. Skilled artisans will know how to operate and manipulate the injection molding machine 10 to achieve a desired concentration of each material in the hybrid article 20. Afterwards, the hybrid material is then allowed to solidify before being extracted from the die halves (then in a mold open position) as the hybrid article 20.

The one or more feeders 12a, 12b may be constructed to deliver the metal and polymer feedstocks to the barrel 14 at the same or different feed point locations depending on the relative amount of heating and mixing required for each respective feedstock material. The metallic and polymer feedstock may be introduced to feeder 12a and, if needed, to feeder 12b at room temperature or in a preheated state.

In one embodiment, feeder 12a may be adapted to receive an amount of metal or alloy feedstock—such as magnesium or aluminum—in the form of granules, pellets, chips, ingot scraps or some combination thereof. The feeder 12a may also simultaneously receive a corresponding amount of high temperature resistant polymer particle feedstock if process conditions allow for such an arrangement. For example, the metallic and polymeric feedstocks may be simultaneously received in feeder 12a if, among others, their desired molding temperatures and associated heating requirements for forming the mixed semi-solid hybrid material are approximately the same or close enough to allow for an identical feedpoint to the barrel 14. Other factors that may also need to be considered include, but are not limited to, the desired concentrations of the metallic and polymer constituents in the molded hybrid article 20 as well as their thixotropic and physical properties. The feeder 12a may be configured to gravity-feed the metal and polymer feedstocks to the barrel 14, or it may outfitted with a connection that can supply the feedstocks under an inert gas blanket such as argon to reduce material oxidation.

If simultaneous feeding of the metallic and polymer feedstock is not feasible, a separate feeder 12b that is similar to feeder 12a may be utilized to ensure that proper thixotropic mixing occurs. In such a situation feeder 12b may be located relative to feeder 12a so that the metallic feedstock and the polymer feedstock may be separately and more appropriately introduced to the barrel 14 based on their expected heating and high shear mixing requirements. It may thus be appropriate to receive metal feedstock in feeder 12a and polymer feedstock in feeder 12b, or vice versa, and to have the feeders 12a, 12b positioned in spaced relation to one another so that proper thixotropic mixing occurs inside the barrel 14. A duel-feeder arrangement of this type is commonly employed in situations where the polymer feedstock requires less heat and/or shear stresses for thixotropic molding when compared to the metal feedstock and, as a result, necessitates a separate and more downstream feedpoint to the barrel 14. The polymer material with the smaller heating and/or mixing requirements may therefore avoid becoming to “liquid” as a consequence of excessive heating/mixing along a greater than necessary axial length of the barrel 14.

The barrel 14 is coupled to the feeders 12a, 12b and defines a flow path 26 along which the metal and polymer feedstocks are heated and mixed into the hybrid combination material. The barrel 14 houses an axially extending, rotatable screw 16 that includes a continuous groove or blade 28 (or a set of isolated grooves or blades). These groove(s)/blade(s) 28 are contoured on the surface of the screw 16 so that rotation of the screw 16 causes the metal and polymer feedstocks to mix at high shear rates while being advanced toward an injection nozzle 30 at the injection end 24 of the barrel 14. Moreover, to provide a source of heat, the barrel 14 may have one or more band heaters 32 circumferentially disposed around its outer surface. The band heaters 32 and the rotatable screw 16 can thus cooperate to induce thixotropic mixing of the metal and polymer material inside the barrel 14 by heating the metal material to a semi-solid state and the polymer material to a melt-processable state and then mixing the two materials by way of high shear stirring. This results in a semi-solid slurry of a metal/polymer hybrid material which may be either, based on the proportions of metal and polymer used, a (1) continuous metal phase with discrete polymer phases dispersed therein; (2) a polymer matrix with discrete metal phases dispersed therein; or (3) a co-continuous combination of metal and polymer phases. The hybrid material is then shot through the nozzle 30 under pressure from the rotatable screw 16 as encroaching downstream hybrid material moves toward the injection end 24. The discharge of the hybrid material from the nozzle 30 and into the mold cavity 22 may take the form of a turbulent stream of atomized spray—a characteristic of thixotropic molding that helps reduce the entrained porosity in the soon-to-be-solidified molded hybrid article 20. The nozzle 30 may be of any suitable size and configuration deemed appropriate for controlling the injection speed of the hybrid material to the mold cavity 22.

The drive mechanism 18 may be coupled to the screw 16 in a manner where it can selectively cause the screw 16 to rotate. Such a drive mechanism 18 may be any conventional mechanism appropriate for a thixotropic injection molding process. For instance, it should be capable of driving the rotatable screw 16 at rates that induce high shear mixing of the metal and polymer materials in the barrel 14. A variety of gear or belt driven motor assemblies are known to skilled artisans and can be utilized to achieve such functions.

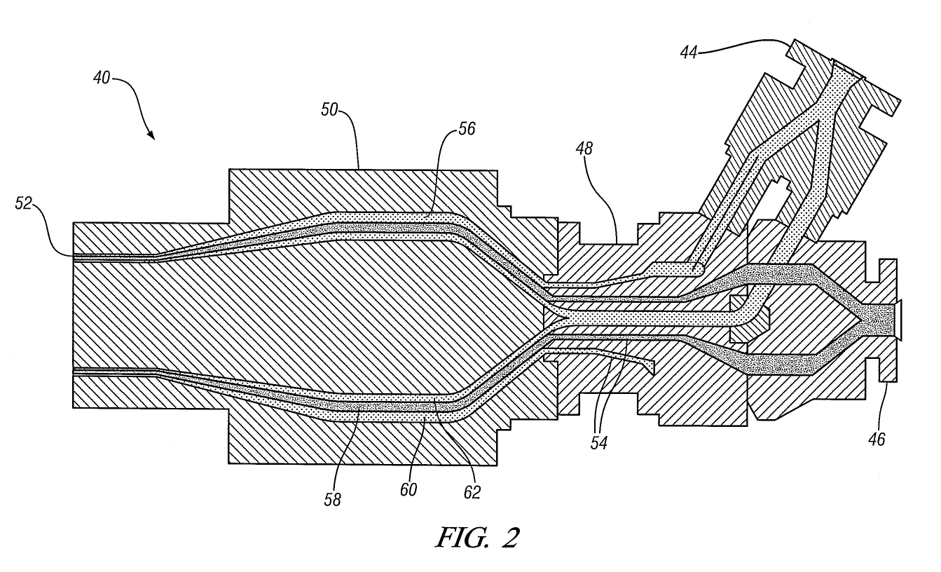

After cooling and/or suitable stiffening, the molded hybrid article 20 may be removed from the mold cavity 22. The hybrid article 20 may represent a finished product or it may be a precursor shape or object that requires some type of additional processing.

Where an extruded hybrid body of light metal and polymer layers is to be formed, a co-extrusion machine and process may be used. FIG. 2 is a schematic illustration of a co-extrusion machine 40 for high shear mixing, temperature control, and extrusion of an extruded solid or hollow hybrid article of two or more layers of metal and polymer. The co-extrusion machine 40 shown includes a first feeder 44, a second feeder 46, a body 48, and a die 50 that defines an exit cavity 52 ultimately corresponding in shape to a multilayer hybrid article to be formed. The general operation of such a co-extrusion machine 40 generally involves separately supplying metal and polymer feedstock to their respective feeders 44, 46 and then forcing the two materials through the body 48 and the die 50. At first, in the body 48, the metal and polymer materials are initially diverted into a predetermined quantity of separate flow streams 54 that correspond in number and alignment to that of the multi-layered hybrid article being formed. Those individual flow streams 54 are eventually combined in an intermediate passageway 56 and advanced through the exit cavity 52 of the die 50 to generate a continuous or semi-continuous output of multilayered hybrid material. This output material is then cut or otherwise shaped into articles of a predetermined shape. Here, the co-extrusion machine 40 is configured with three distinct flow streams 54 to form a hollow, three-layer hybrid article that comprises a metal layer 58 sandwiched between two discrete polymer layers 60, 62. But of course other combinations of metal and polymer layers are possible. For instance, the combination of layers may be reversed such that the polymer layer is sandwiched between two metal layers. In another example a hybrid material flow with only two layers—one polymer and one metal—or a hybrid material flow with more than three distinct alternating layers of metal and polymer may be formed. Co-extruded tubes or solid bars or rods may be formed.

The first feeder 44 and the second feeder 46 are each configured to receive and direct a molten, semi-solid, or otherwise flowable quantity of metal feedstock and polymer feedstock, respectively, to the body 48 of the extrusion device. In this embodiment, feeder 46 receives metal feedstock initially in the form of a preheated billet. As the billet is processed it may be heated to a partially liquid, partially solid state for flow in its extrusion channel(s). A hydraulic press or other ramming device, such as a drive screw, may be used to exert a sufficient force against the preheated metal material and thus push it through the first feeder 44 as well as the remainder of the co-extrusion machine 40. A second feeder 46, on the other hand, typically receives pellatized polymer feedstock. A hydraulic press or ramming device similar to the one used with feeder 44 may also be used to heat and force the flowable polymer feedstock through feeder 46 and through the rest of the co-extrusion machine 40. Both of feeders 44, 46 are capable of being separately controlled for the purpose of allowing them to operate at different optimal extrusion temperatures applicable to their respective metal and polymer feedstock, if necessary.

The co-extruder body 48 is positioned downstream from the feeders 44, 46 and defines the set of co-extrusion passageways 54 that separates and aligns the flow streams of the polymer and metal materials for eventual combination in the extrusion die 50. As shown, the polymer and metal feedstocks enter the extruder body 48 from feeders 44, 46 and are divided into the set of co-extrusion passageways 54 that, at this point, are configured to keep the polymer and metal materials separate from one another. These passageways 54 route the polymer and metal material flows into an alignment commensurate with the desired ordering of layers in the co-extruded hybrid flow that exits the die 50 through the exit cavity 52. The reason for initially keeping the polymer and metal material flows separate is to allow for some slight cooling to occur. This cooling event, which may vary depending on extrusion materials used, helps ensure that the polymer and metal material flows will overlap and underlap one another and form a discretely layered flow of hybrid material as opposed to a non-layered mixture of the two materials. The set of passageways 54 eventually transitions into a single intermediate passageway 56 located in the die 50 where the polymer and metal material flows are combined in layered fashion.

The layered hybrid material then moves through the intermediate passageway 56 and into the exit cavity 52 of the die 50 where it acquires the final or close to final dimensional shape of the hybrid flow from which the hybrid articles are produced. For example, as shown here, the thickness of the layered hybrid material is reduced during the transition from the intermediate passageway 56 to the exit cavity 52. Any suitable device may be located downstream from the co-extrusion machine 40 to cut, shape, or otherwise manipulate the hybrid material flow as it exits the die 50, if desired. For example, the layered hybrid material flow exiting the die may, in some instances, be successively cut into hollow hybrid articles of a predetermined size and then subjected to further processing if necessary.

The above description of embodiments of the invention is merely exemplary in nature and, thus, variations thereof are not to be regarded as a departure from the spirit and scope of the invention.

1. A method of forming a hybrid material article comprising a light metal alloy constituent and a polymer constituent, the article comprising predetermined material proportions of the metal alloy constituent and the polymer constituent; the method comprising:
heating the metal alloy constituent to a semi-solid state and moving it along a flow path at a shear rate for thixotropic molding of the metal alloy constituent;
heating the polymer constituent to a flowable state and moving it along a flow path with the metal alloy;
bringing the metal constituent and polymer constituent into contact along their flow paths; and
cooling the metal alloy and polymer to form the hybrid material article.

2. A method of forming a hybrid material article as recited in claim 1 in which the metal alloy constituent and polymer constituent are mixed in a common flow path to form a hybrid material article comprising mixed phases of the metal alloy and polymer.

3. A method of forming a hybrid material article as recited in claim 1 in which the metal constituent and polymer constituent are co-extruded to form an article having at least one layer of metal and one layer of polymer.

4. A method of forming a hybrid material article as recited in claim 2 in which the hybrid article comprises a continuous metal phase with a discontinuous polymer phase.

5. A method of forming a hybrid material article as recited in claim 2 in which the hybrid article comprises a continuous polymer phase with a discontinuous metal phase.

6. A method of forming a hybrid material article as recited in claim 2 in which the hybrid article comprises a discontinuous metal phase and a discontinuous polymer phase.

7. A method of forming a hybrid article as recited in claim 1 in which the metal constituent is a magnesium-based alloy.

8. A method of forming a hybrid article as recited in claim 1 in which the polymer phase is a liquid crystal polymer.

9. A method of forming a hybrid article as recited in claim 3 in which the co-extruded body has a solid cross-section.

10. A method of forming a hybrid article as recited in claim 3 in which the co-extruded body has a hollow cross-section.

11. A co-molded hybrid material article consisting essentially of a magnesium alloy or an aluminum alloy, and a polymer.

12. A co-molded hybrid material article as recited in claim 11 consisting essentially of mixed microstructural phases of a magnesium alloy or an aluminum alloy, and a polymer.

13. A co-molded hybrid material article as recited in claim 11 consisting essentially of at least one layer of a magnesium alloy or an aluminum alloy co-extruded with at least one polymer layer.

14. A co-molded hybrid material article as recited in claim 11 consisting essentially of a magnesium alloy and a liquid crystal polymer.

15. A co-molded hybrid material article as recited in claim 12 consisting essentially of a magnesium alloy and a liquid crystal polymer.

16. A co-molded hybrid material article as recited in claim 13 consisting essentially of a magnesium alloy and a liquid crystal polymer.

17. A co-molded hybrid material article as recited in claim 13 in which the hybrid material article is co-extruded with a solid cross-section.

18. A co-molded hybrid material article as recited in claim 13 in which the hybrid material article is co-extruded with a hollow cross-section.
